(19) United States
(12) Patent Application Publication
(10) Pub. No.: US 2024/0263668 A1
(43) Pub. Date: Aug. 8, 2024

(54) FASTENER SYSTEM

(71) Applicant: LEATHERMAN TOOL GROUP, INC., Portland, OR (US)

(72) Inventor: Andro PURNOMOHADI, Vancouver, WA (US)

(21) Appl. No.: 18/164,358

(22) Filed: Feb. 3, 2023

(51) Int. Cl. F16C 11/04

(52) U.S. Cl. CPC F16C 11/04; B25B 7/08

(57) ABSTRACT

Provided herein is a fastener system that permits rotation about an axis of the fastener system while holding two or more members together that are pivotable relative to one another. The fastener system of an example includes: a first hub portion defining a first aperture and a key or a keyway; a second hub portion defining a second aperture and a key or a keyway; a fastener, where the fastener passes through the first aperture and secures the first hub portion to the second hub portion, where the key or the keyway of the first hub portion interlocks with the key or the keyway of the second hub portion precluding relative rotation between the first hub portion and the second hub portion, where the first hub portion and the second hub portion define a hub about which two or more joined objects remain rotatable relative to one another.

### TECHNOLOGICAL FIELD

Embodiments of the present disclosure relate generally to fasteners, and more particularly, to a fastener system that permits rotation about an axis of the fastener system while holding two or more members together that are pivotable relative to one another.

### BACKGROUND

Fasteners have long been used to hold elements or members together. Various types of screws, nails, bolts, etc. are each capable of holding two members in fixed relation to one another. Specialty fasteners have been developed that hold two or more members together while allowing a degree of freedom between the two or more members. However, available fasteners suffer from various drawbacks.

### BRIEF SUMMARY OF THE INVENTION

Embodiments of the present disclosure are directed to fasteners, and more particularly, to a fastener system that permits rotation about an axis of the fastener system while holding two or more members together that are pivotable relative to one another. Embodiments provided herein include a fastener system including: a male threaded fastener; a first hub portion defining a through-hole and a first rotation lock feature; and a second hub portion defining a second rotation lock feature and defining a female thread bore, where the fastener system is assembled by the male threaded fastener passing through the through hole and engaging the female threaded bore, where the first rotation lock feature engages the second rotation lock feature to preclude relative rotation between the first hub portion and the second hub portion in response to the fastener system being assembled, where the first hub portion is secured to the second hub portion along an axis defined through the first hub portion and the second hub portion in response to the fastener system being assembled.

According to some embodiments, a first object is secured to a second object in response to the fastener system being assembled through a first hole in the first object and a second hole in the second object. According to some embodiments, the first hub portion defines a first chamfer and the second hub portion defines a second chamfer, where in response to the fastener system being assembled through the first hole in the first object and the second hole in the second object, the first object is pressed by the first chamfer into engagement with the second object, and the second object is pressed by the second chamfer into engagement with the first object. According to some embodiments, the fastener system does not protrude from the first object or the second object. According to certain embodiments, the fastener system is reversable relative to the first object and the second object. The male threaded fastener of an example embodiment defines a tool receiving feature, and where the second hub portion defines a tool receiving feature. The first hub portion, the second hub portion, and the male threaded fastener are, in some embodiments, each made of a hardened material. The hardened material of an example embodiment includes a hardened steel. According to certain embodiments, the male threaded fastener includes a fastener chamfer, where the first hub portion defines a countersink, where the chamfer engages the countersink to press the first hub portion against the second hub portion.

Embodiments provided herein include a fastener system for joining objects rotatable relative to one another including: a first hub portion defining a first aperture and at least one of a key or a keyway; a second hub portion defining a second aperture and at least one of a key or a keyway; a fastener, where the fastener passes through the first aperture and secures the first hub portion to the second hub portion, where the at least one of the key or the keyway of the first hub portion interlocks with the at least one of the key or the keyway of the second hub portion precluding relative rotation between the first hub portion and the second hub portion, where the first hub portion and the second hub portion define a hub about which two or more joined objects remain rotatable relative to one another.

According to some embodiments, the fastener includes a threaded fastener, and the second aperture defines a threaded profile complementary to the threaded fastener. According to some embodiments, the first hub portion defines a first chamfer, where the second hub portion defines a second chamfer, where the two or more joined objects are pressed toward one another between the first chamfer and the second chamfer. The fastener of an example embodiment includes a first driving feature, where the driving feature is configured to enable rotation of the fastener relative to the second hub portion. According to some embodiments, the second hub portion includes a second driving feature, where the second driving feature is configured to enable rotation of the second hub portion relative to the fastener.

According to certain embodiments, the first hub portion and the second hub portion are formed of hardened steel. The first hub portion, the second hub portion, and the fastener are, in certain embodiments, held rotationally fixed relative to one another in response to the fastener securing the first hub portion to the second hub portion. According to some embodiments, the fastener includes a fastener chamfer and the first hub portion defines a countersink, where the fastener chamfer engages the countersink to press the first hub portion against the second hub portion.

Embodiments provided herein include a method of fastening two or more objects together that permits relative rotation between the two or more objects, the method including: receiving a male threaded fastener through a first hub portion and into a second hub portion; driving the first hub portion against the second hub portion with the male threaded fastener; interlocking the first hub portion with the second hub portion; precluding relative rotation between the first hub portion and the second hub portion; and pressing together the two or more objects while permitting relative rotation between the two or more objects. According to some embodiments, driving the first hub portion against the second hub portion with the male threaded fastener includes: driving a driving feature of the male threaded fastener in a first rotational direction; and driving a driving feature of the second hub portion in a second rotational direction opposite the first rotational direction.

According to some embodiments, pressing together the two or more objects while permitting relative rotation between the two or more objects includes: pressing a first object of the two or more objects with a chamfered flange of the first hub portion in a first direction; and pressing a second object of the two or more objects with a chamfered flange of the second hub portion in a second direction, opposite the first direction. According to certain embodiments, interlocking the first hub portion with the second hub portion includes engaging a key of one of the first hub portion and the second hub portion with a keyway of another of the first hub portion and the second hub portion. According to some embodiments, driving the first hub portion against the second hub portion with the male threaded fastener includes pressing a chamfer of the male threaded fastener against a countersink of the first hub portion as the male threaded fastener engages the second hub portion.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 illustrates an exploded view of a fastener system according to an example embodiment of the present disclosure;

FIG. 2 illustrates an end-view along an axis through the fastener system including section line 3-3 according to an example embodiment of the present disclosure;

FIG. 3 illustrates an exploded view of the fastener system of FIG. 2 taken along section line 3-3 according to an example embodiment of the present disclosure;

FIG. 4 illustrates a first hub portion assembled with a second hub portion of a fastener system according to an example embodiment of the present disclosure;

FIG. 5 illustrates a first hub portion assembled with a second hub portion and a male threaded fastener of a fastener system according to an example embodiment of the present disclosure;

FIG. 6 illustrates two objects joined by a fastener system in accordance with an example embodiment of the present disclosure; and

FIG. 7 illustrates an example embodiment of a tool employing the fastener system according to an example embodiment of the present disclosure.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Fasteners are frequently used to fasten objects together. Static fixation between objects is common and can be accomplished in a wide variety of ways. Certain objects require fixation that permits one or more degrees of freedom between the fastened objects, for example, objects that require relative rotation for functionality. Scissors are an example of a tool that requires a fastener that fastens the two parts of a pair of scissors together, while requiring relative rotation between the two parts to be available for functionality. These axial fasteners fasten objects together along a length of the fastener.

A challenge with axial fasteners that require rotation between the fastened objects is one of axial tension. Conventionally, fasteners are secured to a predetermined torque or to achieve a secure fixation between two objects. Axial fasteners that permit rotation between fastened objects need to axially secure the objects, but generally cannot press the objects together with too great of a force as such force would preclude relative rotation. However, in many cases, objects that require relative rotation that are secured by axial fasteners need to be held tightly together to properly function. For example, the two halves of a pair of scissors need to be held in a specific relative position for the cutting nip of the scissors to cut accurately and effectively. Therein lies a challenge of such axial fasteners that need to fasten objects together precisely, but not too tightly.

Further, axial fasteners that include two or more parts (e.g., a screw and a nut) need to be tightly fastened together to prevent relative movement between the two or more parts that could result in loosening of the axial fastener during operation of the objects that require relative rotation.

Embodiments of the present disclosure provide an axial fastener system capable of being securely fastened while permitting relative rotation between fastened objects. Further, embodiments can be made of a variety of materials, and particularly hardened materials that resist wear during operation of the objects rotatably connected. Still further, embodiments enable the force applied across the axial fastener system to be relatively high, while still permitting relative rotation between the connected objects, and not loosening during operation.

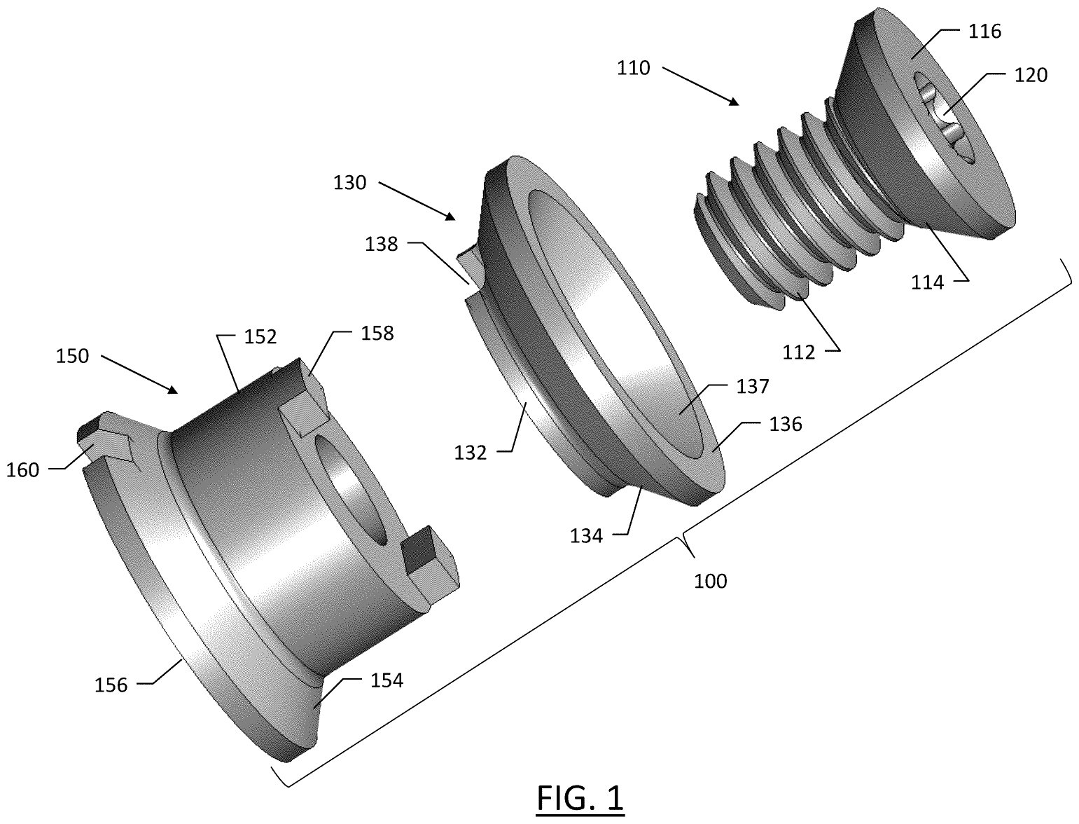

FIG. 1 illustrates an example embodiment of a fastener system 100 shown in an exploded view. The fastener system 100 includes three primary components including a male threaded fastener 110, a first hub portion 130, and a second hub portion 150. The male threaded fastener 110 includes a threaded shaft 112 and a chamfer 114 between the flat head 116 and the threaded shaft 112. The first hub portion 130 includes a first axle portion 132 and a chamfer 134 between the first axle portion 132 and a first outer surface 136 of the fastener system 100. The first hub portion further defines a countersink 137 configured to complement the chamfer 114 of the male threaded fastener 110 and to serve as the surface against which the male threaded fastener presses when the fastener system is assembled. The second hub portion 150 includes a second axle portion 152 and a chamfer 154 between the second axle portion 152 and a second outer surface 156 of the fastener system 100.

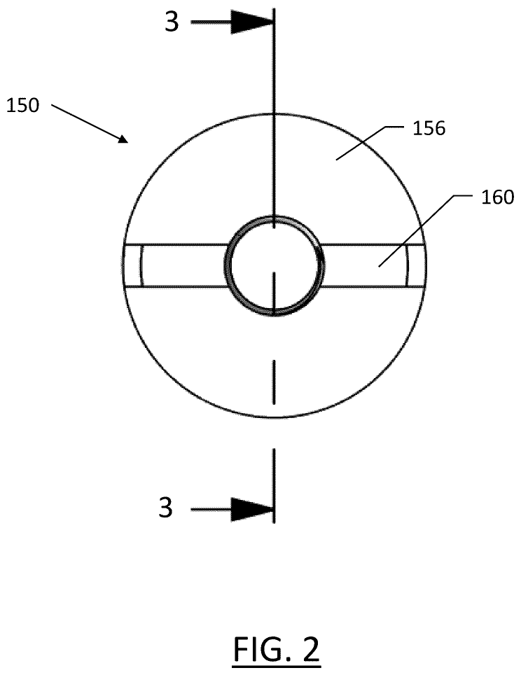

FIG. 2 illustrates a view of the fastener system 100 of FIG. 1 along the axis along which the fastener system extends, and about which the connected objects can rotate. Also shown is section line 3-3. The view of FIG. 2 illustrates the second outer surface 156 of the second hub portion 150. Also shown is tool engagement slot 160. The tool engagement slot 160 depicted is configured to receive therein a tool to at least one of hold the second hub portion 150 rotationally fixed or to drive rotation of the second hub portion. While the illustrated tool engagement slot is configured to engage a typical flat screwdriver, the tool engagement slot 160 of the second hub portion 150 can be embodied by any form of tool cavity (e.g., Philips head, Torx, Allen-key, etc.) to receive therein a tool to hold or rotationally drive the second hub portion, or a protrusion to be engaged by a tool (e.g., a hexagonal head).

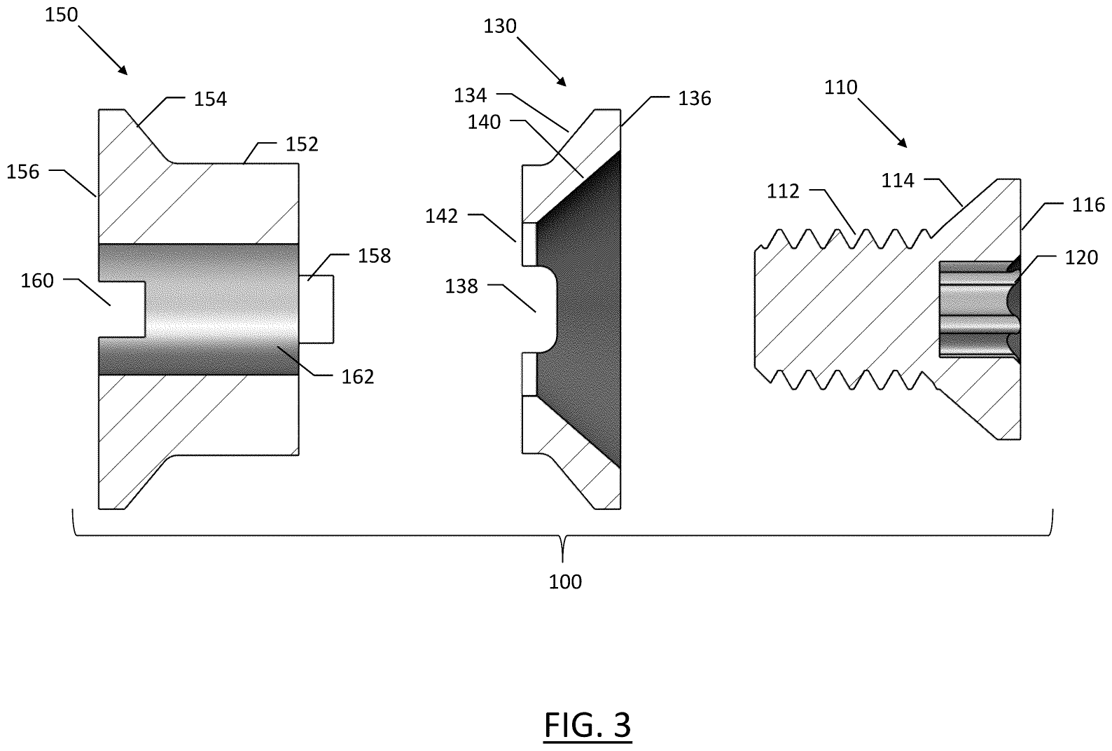

FIG. 3 illustrates the section view of the fastener system 100 of FIGS. 1 and 2 taken along section line 3-3. As shown, the male threaded fastener 110 includes the male threaded shaft 112, the chamfer 114, and the flat head 116. Within the flat head is tool cavity 120 which is configured to receive therein a tool to drive rotation of the male threaded fastener and/or to hold the male threaded fastener rotationally fixed. The tool cavity 120 can be configured for any type of tool capable of driving rotation or holding the fastener rotationally fixed. For example the tool cavity 120 can be a Philips head, Torx, Allen-key, flat head, etc. The tool cavity 120 can be any form of driving feature that enables the fastener to be driven rotationally relative to the second hub portion 150.

The first hub portion 130 includes the outer surface 136 and an inner chamfer 140 that is complementary to the chamfer 114 of the male threaded fastener 110. The first hub portion 130 defines a clearance hole 142 through which the threaded shaft 112 passes when the fastener system 100 is assembled. The second hub portion 150 defines a bore 162 having a female thread configured to engage the male thread of the threaded shaft 112 when the fastener system is assembled.

Also shown in FIG. 3 is a key 158 of the second hub portion 150 and a corresponding complementary keyway 138 of the first hub portion 130. When the first hub portion 130 is assembled together with the second hub portion 150, the two hub portions are held rotationally fixed relative to one another and cannot rotate relative to one another in response to the key 158 engaging the keyway 138. While the first hub portion 130 is shown with the keyway 138 and the second hub portion 150 shown with the key 158, the opposite can also be employed. Further, other rotational fixation mechanisms can be employed, such as mating saw teeth, dowel and pins, etc.

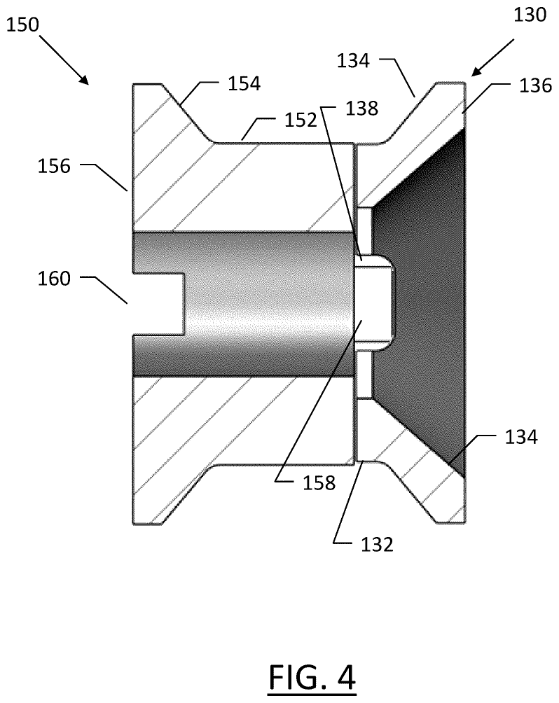

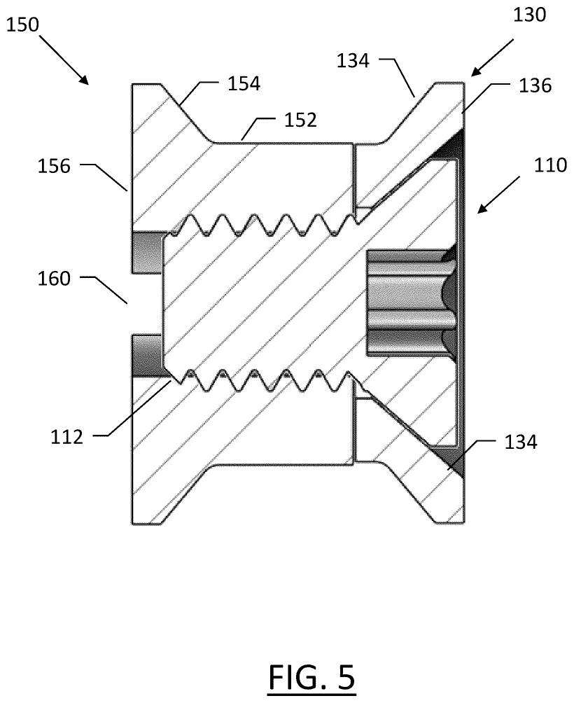

FIG. 4 illustrates the first hub portion 130 mating with the second hub portion 150, where the key 158 engages the keyway 138 to preclude rotation between the first hub portion and the second hub portion. The first hub portion and the second hub portion form an axle with the first axle portion 132 and the second axle portion 152. FIG. 5 illustrates engagement of the male threaded fastener 110 with the second hub portion 150 through the first hub portion 130. As shown, the male threads of the threaded shaft 112 of the male threaded fastener 110 engage complementary female threads of the second hub portion 150. As the male threaded fastener 110 is tightened, the first hub portion 130 is driven toward the second hub portion 150. The chamfer 114 of the male threaded fastener 110 engages the corresponding chamfer 134 of the first hub portion 130 providing a large surface area of contact between the male threaded fastener and the first hub portion. The male threaded fastener 110 is configured such that even when fully seated (i.e., when the first hub portion 130 and the second hub portion 150 are firmly in contact), the threaded shaft 112 does not protrude substantially into the tool engagement slot 160. This maintains functionality of the tool engagement slot 160 when the fastener system is assembled. The tool engagement slot 160 can be embodied by any form of driving feature, such as a tool cavity or raised element (e.g., hexagonal head, Torx head, etc.) that permits driving of the second hub portion rotationally relative to the threaded male fastener 110.

As is evident from FIGS. 4 and 5, the fastener system 100 is reversible as it has a substantially symmetrical outer shape. This allows the fastener system to be installed from either side of a pair of jaws or scissors without prejudice. The fastener system can therefore be installed from the most convenient orientation for the installer.

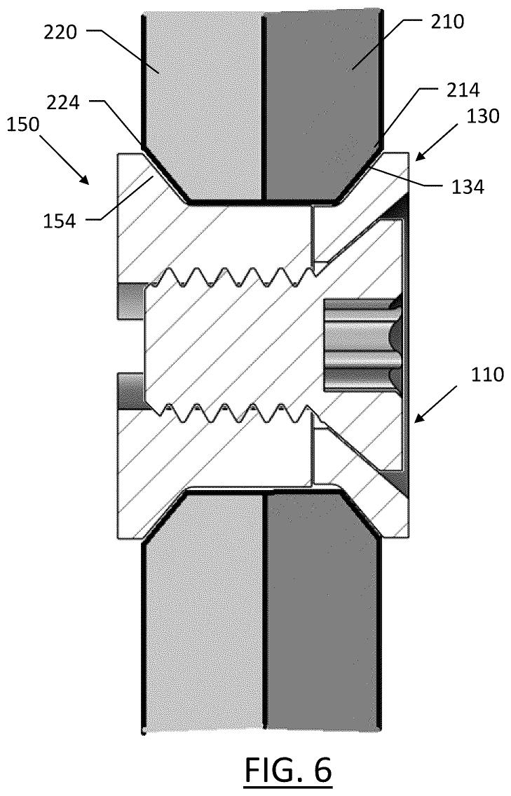

FIG. 6 illustrates the assembled fastener system 100 including the male threaded fastener 110 securing together the first hub portion 130 and the second hub portion. The chamfer 134 of the first hub portion 130 is configured to engage a corresponding chamfer 214 about a hole in a first object 210, while the chamfer 154 of the second hub portion 150 is configured to engage a corresponding chamfer 224 about a hole in a second object 220. The fastener system 100 is sized relative to the first object 210 and the second object 220 to drive the first object toward the second object. The complementary chamfers between the first hub portion 130 and the first object 210 and the second hub portion 150 and the second object 220 allow for a degree of manufacturing tolerance. The first hub portion 130 and the second hub portion 150 do not need to be fully seated against one another, and the fastener system can be securely installed with some “play” or distance between the first hub portion and the second hub portion provided the key engages the keyway and the male threaded fastener 110 has sufficient threaded engagement with the second hub portion 150. This degree of play substantially increases the permissible manufacturing tolerances of the first object and the second object in terms of both thickness or width relative to the fastener system, and the depth of the countersunk chamfered bore. Increasing the permissible manufacturing tolerance can substantially reduce manufacturing costs as higher precision manufacturing is necessarily more expensive with greater potential for waste.

The fastener system 100 of FIG. 6 is shown standing proud of the first object 210 and the second object 220; however, the fastener system can be sized relative to the first and second objects and the recesses therein to sit flush with the outer surfaces of the first and second objects. This may be important in applications where the joined objects, such as scissors or plier jaws, are folded into a multipurpose tool. In such an embodiment, the thickness of the joined objects is critical, and having a fastener that is flush with the joined objects or even recessed within the joined objects is beneficial for overall packaging.

Advantages of the fastener system described herein include the ability to construct the fastener system of any type of material. Often axial fasteners the permit relative rotation between joined objects are made of deformable materials such as rivets. Embodiments of the fastener system described herein can be made of hardened materials, such as those that are tempered or stress relieved to improve their dimensional stability and toughness. Hardened steel is an example of such a material. Constructing the fastener system of hardened steel or other durable material improves the wear properties of the fastener system and therefore extends the useful life of a product employing the fastener system described herein to permit relative rotation between objects.

Further advantages, as described above, include improved tolerance to dimensional inaccuracies of the objects that are fastened together. The fastener system of example embodiments can be tightened to a wide range of torques exhibiting a range of forces applied between two joined objects provided the first hub portion 130 and the second hub portion 150 are not fully seated when joining the objects. The compression applied by the fastener system 100 described herein is limited to a point where the first hub portion and the second hub portion become fully seated.

Another advantage of fastener systems of example embodiments described herein includes the ability to maintain a secure coupling of the fastener system while permitting relative rotation between the first object 210 and the second object 220. Threaded fasteners that couple objects that rotate relative to the fastener can result in the fastener loosening over time as the objects rotate and cause some degree of relative rotation of the threaded fastener. However, embodiments of the present disclosure do not suffer from this drawback as the male threaded fastener 110 is isolated from the first and second objects. This enables the male threaded fastener 110 to maintain secure engagement with the second hub portion 150 regardless of rotation of the first object 210 relative to the second object 220, and rotation of the first and second objects relative to the fastener system. The first hub portion 130 and the second hub portion 150 are held fixed relative to one another by virtue of the rotation lock, which in the illustrated embodiment includes a key 158 and keyway 138. This fixation precludes rotation of the first hub portion 130 relative to the second hub portion 150, which isolates the male threaded fastener 110 from any rotation of the first object 210 or the second object 220. Since the male threaded fastener 110, once secured to the second hub portion 150, does not contact any part that rotates relative to the male threaded fastener, the male threaded fastener maintains engagement with the second hub portion and is not encouraged to become unseated.

Embodiments of the fastener system described herein are well-suited to join together objects that require relative rotation about an axis. These include objects such as scissors including tin snips, shears (e.g., garden shears), cutters (e.g. PVC cutters, band cutters), etc. Further, objects such as pliers including slip joint pliers, tongue and groove pliers, needle nose pliers, locking pliers, wire strippers, linesman pliers, fencing pliers, and cutting pliers, for example, may be rotatably joined by a fastener system as described herein. Embodiments of the fastener system described herein are also suitable for use in hinged joints of objects or any joint that requires relative rotation of two objects, and particularly oscillating or repeated rotation. Oscillating or repeated rotation tends to loosen axial fasteners over time; however, as described above, embodiments of the fastener system described herein are ideally suited for joining objects that rotate and oscillate relative to one another.

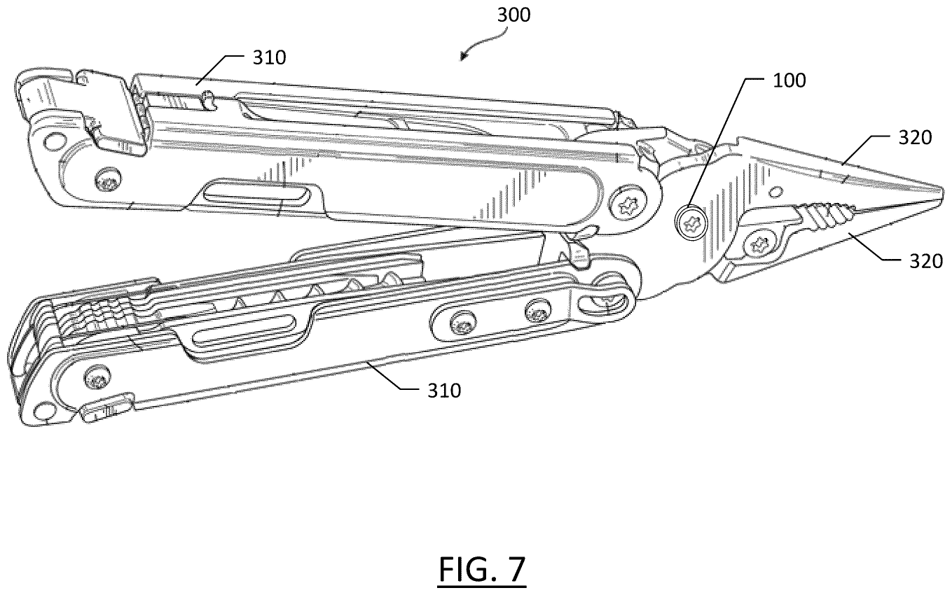

FIG. 7 illustrates an example embodiment of a multipurpose tool 300 including a pair of pliers that implement the fastener of example embodiments described herein. As shown, the multipurpose tool 300 includes a pair of handles 310 and a pair of plier jaws 520. The pivoting connection between the pair of handles 310 and the pair of jaws 320 is facilitated by the fastener system 100 described above. The fastener system 100 ensures a secure, tight fit between the jaws 320 of the pliers such that they can pivot relative to one another and still function appropriately. Securing the jaws across the axis of rotation enables a cutting nip of the pliers to retain proper alignment which improves functionality. Further, repeated operation of the pliers will not serve to loosen the fastener system 100 of example embodiments as the hub about which the pliers rotate is held fixed between the two hub portions, and the fastener connecting the two hub portions does not contact any rotating portion of the pliers.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A fastener system comprising:
a male threaded fastener;
a first hub portion defining a through-hole and first rotation lock feature; and
a second hub portion defining a second rotation lock feature and defining a female threaded bore,
wherein the fastener system is assembled by the male threaded fastener passing through the through-hole and engaging the female threaded bore,
wherein the first rotation lock feature engages the second rotation lock feature to preclude relative rotation between the first hub portion and the second hub portion in response to the fastener system being assembled, and
wherein the first hub portion is secured to the second hub portion along an axis defined through the first hub portion and the second hub portion in response to the fastener system being assembled.

2. The fastener system of claim 1, wherein a first object is secured to a second object in response to the fastener system being assembled through a first hole in the first object and a second hole in the second object.

3. The fastener system of claim 2, wherein the first hub portion defines a first chamfer and the second hub portion defines a second chamfer, wherein in response to the fastener system being assembled through the first hole in the first object and the second hole in the second object, the first object is pressed by the first chamfer into engagement with the second object, and the second object is pressed by the second chamfer into engagement with the first object.

4. The fastener system of claim 3, wherein the fastener system does not protrude from the first object or the second object.

5. The fastener system of claim 3, wherein the fastener system is reversable relative to the first object and the second object.

6. The fastener system of claim 1, wherein the male threaded fastener defines a tool receiving feature, and wherein the second hub portion defines a tool receiving feature.

7. The fastener system of claim 1, wherein the first hub portion, the second hub portion, and the male threaded fastener are each made of a hardened material.

8. The fastener system of claim 7, wherein the hardened material comprises a hardened steel.

9. The fastener system of claim 1, wherein the male threaded fastener comprises a fastener chamfer, and wherein the first hub portion defines a countersink, wherein the fastener chamfer engages the countersink to press the first hub portion against the second hub portion.

10. A fastener system for joining objects rotatable relative to one another comprising:
a first hub portion defining a first aperture and at least one of a key or a keyway;
a second hub portion defining a second aperture and at least one of a key or a keyway; and
a fastener, wherein the fastener passes through the first aperture and secures the first hub portion to the second hub portion, wherein the at least one of the key or the keyway of the first hub portion interlocks with the at least one of the key or the keyway of the second hub portion precluding relative rotation between the first hub portion and the second hub portion, and
wherein the first hub portion and the second hub portion define a hub about which two or more joined objects remain rotatable relative to one another.

11. The fastener system of claim 10, wherein the fastener comprises a threaded fastener, and wherein the second aperture defines a threaded profile complementary to the threaded fastener.

12. The fastener system of claim 10, wherein the first hub portion defines a first chamfer, wherein the second hub portion defines a second chamfer, and wherein the two or more joined objects are pressed toward one another between the first chamfer and the second chamfer.

13. The fastener system of claim 10, wherein the fastener includes a first driving feature, wherein the first driving feature is configured to enable rotation of the fastener relative to the second hub portion.

14. The fastener system of claim 13, wherein the second hub portion comprises a second driving feature, wherein the second driving feature is configured to enable rotation of the second hub portion relative to the fastener.

15. The fastener system of claim 10, wherein the first hub portion and the second hub portion are formed of hardened steel.

16. The fastener system of claim 10, wherein the first hub portion, the second hub portion, and the fastener are held rotationally fixed relative to one another in response to the fastener securing the first hub portion to the second hub portion.

17. The fastener system of claim 10, wherein the fastener comprises a fastener chamfer, and wherein the first hub portion defines a countersink, wherein the fastener chamfer engages the countersink to press the first hub portion against the second hub portion.

18. A method of fastening two or more objects together that permits relative rotation between the two or more objects, comprising:
receiving a male threaded fastener through a first hub portion and into a second hub portion;
driving the first hub portion against the second hub portion with the male threaded fastener;
interlocking the first hub portion with the second hub portion;
precluding relative rotation between the first hub portion and the second hub portion; and
pressing together the two or more objects while permitting relative rotation between the two or more objects.

19. The method of claim 18, wherein driving the first hub portion against the second hub portion with the male threaded fastener comprises:
driving a driving feature of the male threaded fastener in a first rotational direction; and
driving a driving feature of the second hub portion in a second rotational direction, opposite the first rotational direction.

20. The method of claim 18, wherein pressing together the two or more objects while permitting relative rotation between the two or more objects comprises:
pressing a first object of the two or more objects with a chamfered flange of the first hub portion in a first direction; and
pressing a second object of the two or more objects with a chamfered flange of the second hub portion in a second direction, opposite the first direction.
